(19) United States
(12) Patent Application Publication
(10) Pub. No.: US 2006/0100969 A1
(43) Pub. Date: May 11, 2006

(54) Learning-based method for estimating cost and statistics of complex operators in continuous queries

(76) Inventors: Min Wang, Cortlandt Manor, NY (US); Sriram K. Padmanabhan, San Jose, CA (US); Like Gao, Burlington, VT (US)

Correspondence Address: GEORGE A. WILLINGHAN, III;AUGUST LAW GROUP, LLC, P.O. BOX 19080, BALTIMORE, MD, 21281-9080, US

(21) Appl. No.: 10/984,323

(22) Filed: Nov. 8, 2004

(51) Int. Cl. G06F 17/00

(52) U.S. Cl. 705/400

(57) ABSTRACT

A learning-based method for estimating costs or statistics of an operator in a continuous query includes a cost estimation model learning procedure and a model applying procedure. The model learning procedure builds a cost estimation model from training data, and the applying procedure uses the model to estimate the cost associated with a given query. The learning procedure uses a feature extractor and a cost estimator. The feature extractor collects relevant training data and obtains feature values. The extracted feature values are associated with costs and used to create the cost estimator. When applying the cost estimator to a continuous stream of data, the feature extractor extracts feature values from the data stream and uses the extracted feature values as inputs into the cost estimator to obtain the desired cost values.

### FIELD OF THE INVENTION

The field of the invention is directed to data base query optimization.

### BACKGROUND OF THE INVENTION

Long standing queries, also referred to as continuous queries, are issued once and evaluated continuously, for example over a continuous stream of data, at regular intervals, once every day, or at the occurrence of a pre-defined event, for example every time new data are added to a database. Continuous queries are utilized in a variety of applications, in particular applications that monitor streaming data sources for the occurrence of specific events. The notion of continuous queries as a class of queries that are issued once and then run continuously over databases was introduced in D. Terry, D. Goldberg, D. Nichols and Oki, Continuous Queries Over Append-Only Databases, International Conference on Management of Data Proceedings, San Diego, Calif., pp. 321-330 (1992). In the decade that followed, the database research community showed great interest in continuous queries. This interest increased sharply due to the emerging needs of Data Stream Management Systems (DSMS).

The difference between a traditional file system, for example a Database Management System (DMS), and a DSMS is described in S. Babu and J. Widom, Continuous Queries Over Data Streams, Technical Report, Stanford University Database Group (March 2001). Traditional file systems expect all data to be managed within some form of persistent data set, i.e. a stored data set. A stored data set is appropriate when significant portions of the data are queried again and again, and updates are small or relatively infrequent. In a DSMS, data are contained in a data stream that is possibly unbounded, representing data that are changing constantly, often exclusively through insertions of new elements. Therefore, operations that cover large portions of the data contained within the data stream multiple times are either unnecessary or impractical.

As in traditional database systems, optimal query execution plans for continuous queries in any DSMS are desirable. Different query optimization frameworks for DSMS's have been proposed in recent years. The two most prominent proposed frameworks are rate-based query optimization frameworks, as illustrated in S. Viglas and J. F. Naughton, Rate-Based Query Optimization for Streaming Information Sources, Proceedings of the 2002 ACM SIGMOD International Conference on Management of Data, pp. 37-48, Madison, Wis., Jun. 3-6, 2002, and continuously adaptive continuous queries over streams framework, as illustrated in S. Madden, M. A. Shah, J. M. Hellerstein and V. Raman, Continuously Adaptive Continuous Queries Over Streams, Proceedings of the 2002 ACM SIGMOD International Conference on Management of Data, pp. 49-60, Madison, Wis., Jun. 3-6, 2002. In both frameworks, a fundamental building block is accurate cost estimation for various types of operators in the continuous queries. Cost estimation refers to the estimated total resource usage necessary to execute the query. A unit of cost does not directly equate to any actual elapsed time but provides a rough, relative estimate of the resources, i.e. cost, required by the database manager to execute two plans for the same query. Cost is derived from a combination of central processing unit cost in number of executed instructions and input-output cost in numbers of seeks and page transfers.

In order to reduce cost in a continuous query system, the amount of storage and computation that is required to satisfy many simultaneous queries running in the system is minimized. Given thousands of queries over dozens of data sources, queries will overlap significantly in the data sources they are analyzing. Query processing is further complicated by the long running nature of continuous queries. For example, query cost estimates that were accurate when a query was first posed may be wrong at some later time but before the query is actually removed from a given system.

While the cost of simple operators can be estimated easily, the cost of complex user-defined operators in continuous queries is very difficult to estimate using any traditional cost estimation methods. In addition, the cost of these complex, user-defined operators can vary significantly over time. Inaccurate cost estimation typically results in a sub-optimal query execution plan that ultimately results in poor performance.

A variety of methods are used to estimate the cost associated with a query including the histogram method, curve fitting, sampling and methods based on query feedback. The histogram method is most commonly used in database systems due to its computational efficiency and independence of data distribution. A feature common to each of these methods is an attempt to capture the underlying data distribution as precisely as possible under certain storage constraints. These captured data distributions are then used to estimate the cost of operators.

When dealing with continuous queries, a different approach is needed due to the difference between a traditional query and a continuous query. In a traditional query, the database is assumed to be static, and the queries are ad-hoc. Therefore, the system needs to handle any possible query, which is why most existing techniques that are applied to static databases attempt to capture the entire underlying data distribution. In a continuous query, however, the query is long standing, and the database changes, sometimes as often as each time the query is evaluated.

### SUMMARY OF THE INVENTION

The exemplary aspects of the present invention are directed to methods for estimating cost and statistics of operators in continuous queries over a changing database or stream of data. The continuous query is substantially fixed or static compared to the stream of data. The method in accordance with exemplary aspects of the present invention only considers or analyzes portions of the data stream that are relevant to a given query operator. In addition, the method considers the evolution of any changes in the data stream since the content of the data stream changes over time.

The method in accordance with exemplary aspects of the present invention is a learning-based method for directly estimating cost and statistics that includes an estimation model learning procedure and an estimation model applying procedure. The estimation model learning procedure includes a feature extractor and a cost estimator. The feature extractor is used to obtain feature values and costs from streaming data in training runs, to reduce data volume and to extract relevant parts of the data. In one embodiment, when the database is updated, the feature extractor works incrementally to increase the efficiency. The cost estimator is used to build a cost estimation model by using the feature values extracted from the training data. The feature extractor obtains these feature values from the underlying data, and the cost estimator uses the extracted feature values as inputs. The applying procedure uses the cost estimation model to calculate costs and statistics for an actual data stream. For a given stream of data to be queried, the feature extractor extracts the feature values. The cost estimator uses the extracted feature values to obtain the cost estimate.

### BRIEF DESCRIPTION OF THE DRAWINGS

FIG. 1 is a flow chart of an embodiment of a method for estimating costs in continuous queries in accordance with exemplary aspects of the present invention;

FIG. 2 is an illustration of a similarity-based search over a streaming time series;

FIG. 3 is an illustration of a discrete Fourier transformation of a pattern series;

FIG. 4 is an illustration of a sliding discrete Fourier transformation of a streaming time series;

FIG. 5 is an embodiment of a plot of pattern ranking versus approximation coefficients for use in determining index ranges associated with streaming time series;

FIG. 6 is a flow chart of an embodiment of creating a decision tree cost estimator in accordance with exemplary aspects of the present invention; and

FIG. 7 is a flow chart illustrating an embodiment of the application of the decision tree cost estimator for a continuous data stream.

### DETAILED DESCRIPTION

Exemplary aspects of the present invention are directed to methods for directly estimating cost and statistics in continuous, static queries over one or more continuously changing databases or streams of data. In one embodiment, queries monitor one or more streams of data for an indication or occurrence of an event. For example, queries can monitor banking or other financial transactions for an indication of identity theft or credit card fraud. In addition, queries can monitor the sales of certain commodities, i.e. fertilizer, or immigration activity for an indication of likely terrorist activity. In one embodiment, a given query analyzes one or more features in a given stream of data.

Unlike cost estimation methods for ad-hoc queries over static databases that capture the data distribution in advance and that use the captured data distribution to determine the cost of a specific query operator at the query evaluation time, methods in accordance with exemplary aspects of the present invention directly estimate the cost associated with a given query operator or feature from the input data contained in the stream of data. As used herein, cost refers to the estimated total resource usage necessary to execute the given query. These resources include processor usage, memory usage and network usage among others. In one embodiment, the cost of a query operator, COST, is determined from the input data D. This estimation is represented by the equation COST=f(D), where f is a fixed estimation function for the query operator for which cost is being estimated.

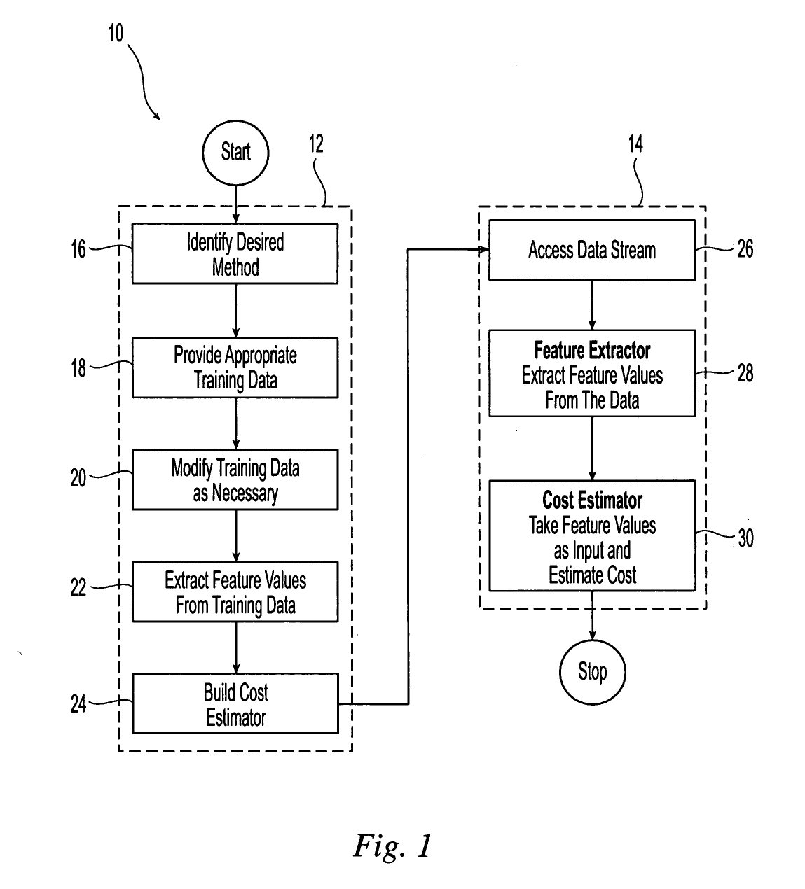

Referring to FIG. 1, an embodiment of a method for directly estimating and applying cost associated with a query 10 is illustrated. In one embodiment, the method for estimating and applying cost in a query includes a process for learning or creating a query cost estimator 12 and a process for applying the learned query cost estimator 14. The process for creating the cost estimator utilizes a user-defined sample or training stream of data, and the created cost estimator is applied to one or more actual streams of data over which the query is conducted. Initially, one or more desired methods for use in creating or building the cost estimator is identified 16. Suitable methods for use in building the cost estimator include learning-based methods, decision tree methods, regression, polynomial functions, histograms and combinations thereof. In general, strategies to create the cost estimator are classified into two approaches, analytic approaches and empirical approaches. In an analytic approach, the cost estimator that uses the extracted features or data as input is created by analyzing the underlying evaluation procedure of an operator, for example an operator within the given query. When these operators are complex or complicated or involve multiple resources, however, the empirical approach is preferably used to create the cost estimator, because experimental data of the continuous query can be used as training evaluation data, and available data mining algorithms can be used to build the cost estimator and to analyze the data.

Based upon the desired method for creating the cost estimator, appropriate training data are provided 18. The training data stream is created to simulate the complexities and ranges of data values for which a given query is to be utilized for monitoring. In one embodiment where the identified method includes using historical data to train a decision tree, the training data set contains actual data from historical runs of the query including query results and costs associated with obtaining those query results. Since the methods used to extract information and features from the data that are necessary to produce the cost estimator may require that the data be present in a particular form, the data that are provided and extracted can be converted into a data type or form that is suitable for use in the method identified for building the cost estimator 20.

Since any given stream of data represents a large volume of input data for the query to process and the types of input data contained in the stream of data are often complex, methods in accordance with exemplary aspects of the present invention focus on those aspects of the stream of data that are relevant to the query and that will produce results to the query in the most cost effective manner. Therefore, after the training data stream is provided, the features or data from the stream of data that are relevant to the query and the complex operators that constitute the query are extracted 22. Extracting the relevant data or feature values from the stream of data reduces the volume of data that is used or analyzed in creating the cost estimator. Another exemplary aspect of the present invention involves a method for extracting features for complex operators. In one embodiment, the feature extractor is determined manually in that the user defines the features within a given stream of data that are to be extracted. In another embodiment, a dedicated incremental procedure is developed to obtain feature values in order to reduce the overhead. A cost estimator is then built 24 using the values of the extracted data or features from the training data stream and the associated costs as inputs.

Having built the cost estimator, the query cost estimator is applied 14, for example to monitor one or more continuous streams of data. In order to apply the cost estimator, the data streams to be monitored are accessed 26, and the relevant features or data are extracted from the stream of data 28. The extracted feature values are used as inputs to the cost estimator, and a cost associated with the data is calculated 30. In one embodiment, the fixed estimation function, f, that was introduced to define the estimated cost is decomposed to two components. The first component represents feature extraction 28, and the second component represents cost estimation 30. In particular, the fixed estimation function can be represented in the following form, COST=s(e(D)), where the functions e( ) represents feature extraction and the function s( ) represents the cost estimation.

Besides estimating cost, methods in accordance with exemplary aspects of the present invention are used to estimate other statistics of complex operators for continuous queries over streaming data. These statistics include output size. Overall, the cost estimation method in accordance with exemplary aspects of the present invention provides accurate estimates with low overhead.

Once the cost is estimated, the queries are conducted inversely by cost and weighted in accordance with the ones that are capable of yielding or producing a determination of the query the quickest, i.e. produce a negative result the quickest so that query evaluation can be stopped at the earliest point if a positive result to the query is unlikely.

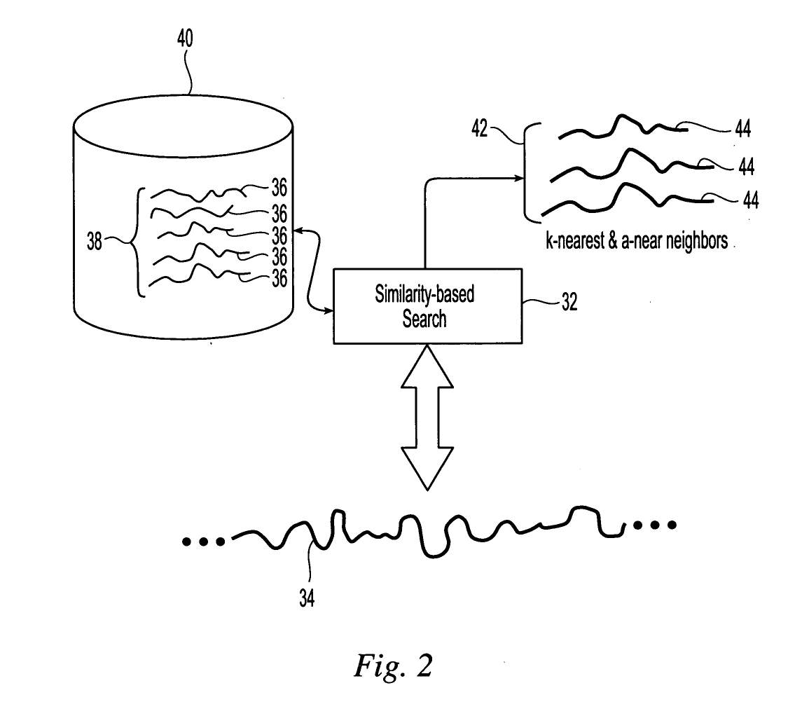

Referring to FIG. 2, an embodiment of the method for estimating costs associated with a continuous query over a stream of data is illustrated. The query 32 monitors an input data stream 34. As illustrated, the query 32 is a similarity-based search. Operators in a similarity-based query, at each time position, search the streaming time series in the input data stream 34 for time series patterns 36 defined in a pre-defined pattern set 38 contained, for example, in a database 40 or other computer readable storage medium that is accessible by the query 32. A streaming time series is an infinite sequence of real numbers whose values are assumed to arrive sequentially, and a time series 36 is a finite sequence of n real numbers.

The time series patterns 36 contained within the pre-defined pattern set 38 are selected based upon the similarity of these time series patterns 36 to streaming time series contained in the input data steam 34 that are of interest in the query. The similarity between a streaming time series contained within the input data stream 34 and each one of the time series patterns 36 is measured by the weighted Euclidean distance
sim(S, PTᵢ)=\sqrt{Σ₀ⁿ⁻¹(qᵢ−sₜ₊ᵢ₋ₙ₊1)²/n},
where PTᵢ=<p₀, p₁, . . . pₙ₋₁> is a time series pattern 36 and <sₜ₋ₙ₊₁, sₜ₋ₙ₊₂, . . . sₜ> is the n-suffix of the streaming time series S in the input data stream 34 up to time t.

Given an integer k, called a similarity rank, and a real number α, called a similarity threshold, a time series pattern 36 PTᵢ in the set of patterns 38 is a k-nearest and a-near neighbor of a given streaming time series in the input data stream 34 if there exist at most k−1 patterns 36 PTᵢ in the set of patterns 38 such that
sim(S, PTᵢ)>sim(S, PTⱼ) and sim(S, PTᵢ)≦α.
A k-nearest and a-near neighbor is also referred to as a k-a-near neighbor.

For a given stream of data 34, a given streaming time series and given values for similarity rank k and threshold a, the similarity-based search query 32 creates a solution set 42 containing a plurality of matching pattern time series 44 at each data arrival time t, which represents all k-a-near neighbors up to time t of the streaming time series from the original set of patterns 38.

In order to conduct the similarity-based search query 32 in the most cost effective way in accordance with exemplary aspects of the present invention, a query cost estimator is created for estimating the cost associated with the similarity-based search query, and the cost estimator is used to estimate the cost of conducting the query for a given stream of data. Initially, the use of historical data is identified as the method to be used to build the cost estimator and historical training data are provided for use in creating the cost estimator. The historical data include pattern and streaming time series data from historical runs and costs associated with these data.

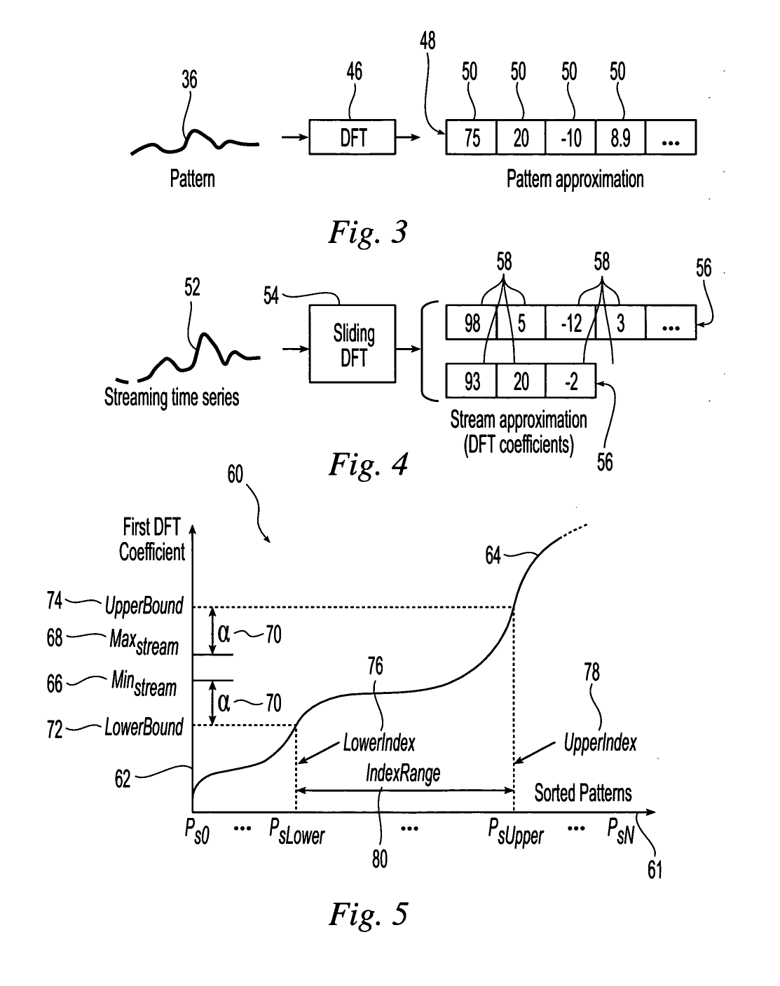

In order to build the cost estimator, feature values are extracted from the historical pattern and streaming time series data so as to minimize estimation overhead and to reduce the volume of data involved in the estimation process. In this embodiment in order to minimize the estimation overhead, the feature values in the historical data are converted using data approximations of the pattern time series and streaming time series contained in the historical data. Initially as illustrated in FIG. 3, each time series pattern 36 is approximated, preferably using Discrete Fourier Transform (DFT) 46. The DFT approximation yields a pattern approximation 48. Each time series pattern has a length n and is approximated by a plurality of its significant DFT coefficients 50. Although the larger the number of coefficients used the more accurate the approximation, each time series pattern is preferably approximated by the smallest possible number of significant DFT coefficients to keep the extraction process as simple as possible. Since each pattern time series is static, these approximations can be performed in advance using a standard n-point DFT operation and stored with the pattern in the database.

Having approximated the time series patterns, each streaming time series 52, as illustrated in FIG. 4, is also approximated using DFT, preferably sliding DFT 54 since streaming time series change over time. For example, a streaming time series of given length n can be viewed as a window of length n over the continuous data stream 34 being monitored. As the continuous data stream passes in front of this window over time, the content of the n-length streaming time series changes. The change in the streaming time series results in a change in the DFT approximation, and sliding DFT is used to provide the necessary incremental updating of the approximation. Therefore, sliding DFT 54 produces a plurality of streaming time series approximations 56. The streaming time series approximations contain coefficients that due to the changing streaming time series can vary from approximation to approximation. A plurality of streaming time series approximations is generated corresponding to each time series pattern length n. As with the time series patterns, each n-suffix of the streaming time series is approximated by the smallest number of significant DFT coefficients possible.

Having placed the pattern and continuous time series historical data in the desired format using DFT based approximations, feature values are then extracted from the data. In one embodiment, as illustrated in FIG. 5, a plot of the ranking of sorted pattern approximations versus DFT approximation coefficients 60 is created. For purposes of simplifying the embodiment, only the first DFT coefficients of the pattern time series and streaming time series approximations are used in the illustration. To create the plot, all of the pattern time series are sorted in increasing order by their first DFT coefficients. The pattern time series are assigned new indices that correspond to their ranks in the sorted list. The x-axis 61 of the plot 60 represents the indices, i.e. ranks, of the pattern time series. The y-axis 62 represents the approximation values, i.e. DFT coefficients. A monotonic increasing curve 64 can be drawn representing the first DFT coefficients corresponding to the patterns in the pattern set after sorting.

For each one of a plurality of lengths, n, of the pattern time series, incremental DFT is used to generate a plurality of approximations of the streaming time series up to the current time. In other words, for a given pattern length, n, a plurality of approximations of the streaming time series are generated using incremental DFT. Each plurality of streaming time series approximations contains a minimum value 66, Minₛₜᵣₑₐₘ and a maximum value 68, Maxₛₜᵣₑₐₘ. These minimum and maximum values are plotted on the y-axis, and a DFT coefficient range is determined for the approximation by subtracting from Minₛₜᵣₑₐₘ and adding to Maxₛₜᵣₑₐₘ a pre-determined value α 70. Preferably, α is equal to a, the similarity threshold. Therefore, a LowerBound 72 for the DFT coefficient equal to Minₛₜᵣₑₐₘ−a and an UpperBound 74 for the DFT coefficient equal to Maxₛₜᵣₑₐₘ+a are defined. Using the plot 60, LowerBound is used to obtain a Lowerlndex 76, and UpperBound 74 is used to generate an UpperIndex 78 on the corresponding ranked indices. The difference between the Lowerlndex 76 and the UpperIndex 78 is the IndexRange 80 associated with the continuous stream series approximations corresponding to each pattern length n. In one embodiment, each pattern 36 can have a distinct length, i.e. length n can vary from pattern to pattern, and the approximations of a streaming time series can have different lengths. The result, therefore, is a historical record of the rank range for an “n” length pattern having a pre-defined degree of similarity in a continuous data stream.

Since the historical data also contain the actual historical costs associated with patterns and hence the indices, the IndexRange 80 can be associated with known costs. Therefore, for each plurality of continuous series approximations, UpperIndices, LowerIndices, IndexRanges and associated costs are generated. Since all of the UpperIndices and LowerIndices are based upon the same plot 60 generated by the corresponding pattern time series approximations, the IndexRanges and associated costs can be combined to form a cost estimator, for example in the form of a decision tree based upon the IndexRanges.

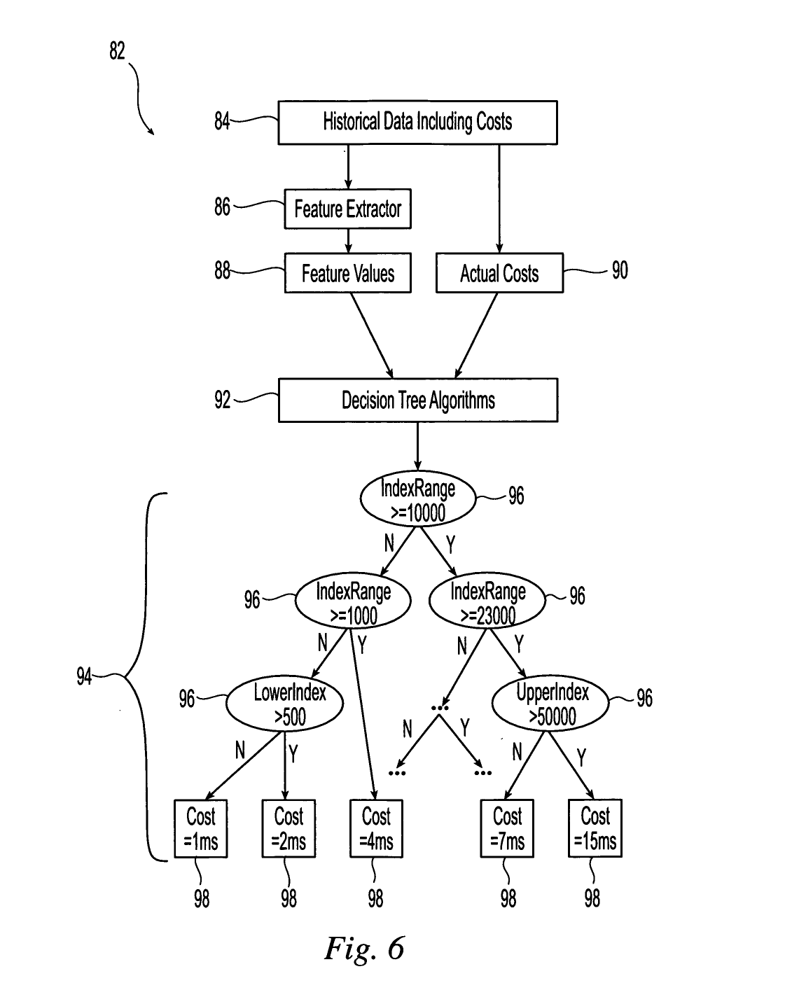

An embodiment for creating the index range decision tree 82 is illustrated in FIG. 6. From a database containing the historical data including cost data 84, features are extracted 86 and feature values are calculated 88 in accordance with the present embodiment. The actual historical costs 90 associated with the historical data from previous runs of the similarity-based search are combined with the features values 88, in particular the index ranges, and are used by a decision tree generating algorithm 92 to produce a historical data-based cost estimating decision tree 94. The decision tree contains a plurality of decision points or nodes 96 based upon the index ranges and a plurality of resulting costs 98.

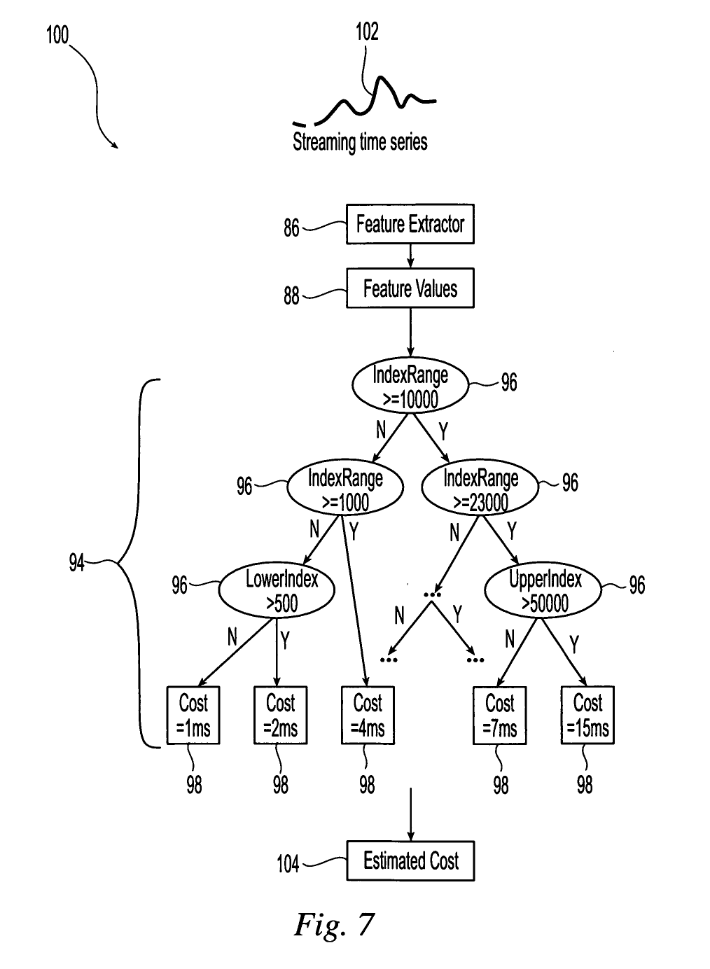

Referring to FIG. 7, an application 100 of the decision tree cost estimator 94 is illustrated for a random streaming time series 102 obtained from a continuous data stream. At each time position for the streaming time series, the relevant features are extracted 86, and the feature values are calculated 88. Since the pattern time series are static, the approximation step for the static pattern time series does not need to be performed. The feature values yield the IndexRange 80, which is used in the cost estimator tree to calculate the associated cost 104.

The resulting costs are used to determine how to most cost effectively conduct the continuous query over the data stream. For example, the query can be conducted so as to execute those operators within the queries having the lowest associated cost first. In addition, the operators within the queries can be executed in an order such that the operators that are capable of producing a negative result for the query first and with the lowest cost are executed first. For example, if a particular operator or condition with the query has to be true for the query to be satisfied, then a false condition allows the query to be halted immediately before any other calculations or operations are conducted.

Exemplary aspects of the present invention are also directed to computer readable mediums containing a computer executable code that when read by a computer causes the computer to perform a method for estimating costs and statistics of complex operators in continuous queries in accordance with exemplary aspects of the present invention and to the computer executable code itself. The computer executable code can be stored on any suitable storage medium or database, including databases in communication with and accessible to the system storing the historical query data, and can be executed on any suitable hardware platform as are known and available in the art.

While it is apparent that the illustrative embodiments of the invention disclosed herein fulfill the objectives of exemplary aspects of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of exemplary aspects of the present invention.

What is claimed is:

1. A method for estimating costs for continuous queries over streaming data, the method comprising:
creating a query cost estimator capable of associating costs to features in a stream of data for a continuous query; and
applying the cost estimator to the features in one or more streams of data to estimate costs associated with conducting the continuous query over the streams of data.

2. The method of claim 1, wherein the step of creating the cost estimator comprises:
identifying a method for use in creating the cost estimator; and
providing training data in accordance with the identified method to be used in creating the cost estimator.

3. The method of claim 2, wherein the method for use in creating the cost estimator comprises a learning-based method and the step of providing training data comprises providing data from historical runs of the continuous query, the data comprising feature values and associated costs.

4. The method of claim 2, further comprising converting the training data into a form suitable for use in the identified method for creating the cost estimator.

5. The method of claim 4, wherein the step of converting the training data comprises using discrete Fourier transformation to generate approximations of the training data.

6. The method of claim 2, further comprising:
extracting relevant feature values from the training data;
associating costs with the relevant feature values; and
using the extracted feature values and associated costs to create the cost estimator.

7. The method of claim 1, wherein the step of applying the cost estimator comprises accessing a stream of data, extracting relevant feature values from the stream of data and inputting the extracted feature values into the cost estimator to derive the associated costs.

8. The method of claim 1, further comprising using the estimated cost in conducting the continuous query.

9. The method of claim 8, wherein the step of using the estimated cost comprises conducting the continuous query on features in the data stream inversely by estimated cost.

10. A computer readable medium containing a computer executable code that when read by a computer causes the computer to perform a method for estimating costs in continuous queries over streaming data, the method comprising:
creating a query cost estimator capable of associating costs to features in a stream of data for a continuous query; and
applying the cost estimator to the features in one or more streams of data to estimate costs associated with conducting the continuous query over the streams of data.

11. The computer readable medium of claim 10, wherein the step of creating the cost estimator comprises:
identifying a method for use in creating the cost estimator; and
providing training data in accordance with the identified method to be used in creating the cost estimator.

12. The computer readable medium of claim 11, wherein the method for use in creating the cost estimator comprises a learning-based method and the step of providing training data comprises providing data from historical runs of the continuous query, the data comprising feature values and associated costs.

13. The computer readable medium of claim 11, further comprising converting the training data into a form suitable for use in the identified method for creating the cost estimator.

14. The computer readable medium of claim 13, wherein the step of converting the training data comprises using discrete Fourier transformation to generate approximations of the training data.

15. The computer readable medium of claim 11, further comprising:
extracting relevant feature values from the training data;
associating costs with the relevant feature values; and
using the extracted feature values and associated costs to create the cost estimator.

16. The computer readable medium of claim 10, wherein the step of applying the cost estimator comprises accessing a stream of data, extracting relevant feature values from the stream of data and inputting the extracted feature values into the cost estimator to derive the associated costs.

17. The computer readable medium of claim 10, further comprising using the estimated cost in conducting the continuous query.

18. The computer readable medium of claim 17, wherein the step of using the estimated cost comprises conducting the continuous query on features in the data stream inversely by estimated cost.
